(19) United States
(12) Patent Application Publication
(10) Pub. No.: US 2019/0266566 A1
(43) Pub. Date: Aug. 29, 2019

(54) Shelf Tag Apparatus, Systems, and Methods for Inventory Picking and Tracking

(71) Applicant: Trevor I. Blumenau, Plano, TX (US)

(72) Inventor: Trevor I. Blumenau, Plano, TX (US)

(21) Appl. No.: 16/396,850

(22) Filed: Apr. 29, 2019

Related U.S. Application Data
(63) Continuation-in-part of application No. 15/469,479, filed on Mar. 24, 2017.
Application No. 15/469,479 is a continuation of application No. 15/257,964, filed on Sep. 7, 2016, now abandoned.

(51) Int. Cl. G06Q 10/08; G06F 16/22; G06K 7/10

(52) U.S. Cl. CPC G06Q 10/0875; G06Q 10/087; G06K 7/10386; G06F 16/22

(57) ABSTRACT

The present invention includes a shelf tag hub for inventory related communication with one or more shelf tags, the shelf tag hub including a processor, memory, and a wireless network adapter. The wireless network adapter is a modified Bluetooth protocol radio and configured with a transmission signal for a target transmission distance, defining a transmission region for communication with shelf tags disposed therein.

### FIELD OF THE INVENTION

The invention relates generally to order picking and inventory, and more particularly, to apparatus, systems, and methods for electronic shelf tag communication.

### BACKGROUND

The order picking operation is one of the key steps in the fulfillment process. It consists of taking and collecting inventory of specified quantities to complete a customer's order prior to shipment. In various types of order picking, the order picker(s) move about the warehouse to shelving within the warehouse in order to collect the inventory necessary for one or more orders. A portable computer and electronic shelf tags facilitate the order picking process. This invention addresses these and other issues.

### SUMMARY

The present invention includes a shelf tag hub for inventory related communication with one or more shelf tags, the shelf tag hub including a processor, memory, and a wireless network adapter. The wireless network adapter is a modified Bluetooth protocol radio and configured with a transmission signal for a target transmission distance, defining a transmission region for communication with shelf tags disposed therein.

These and other features, aspects, and advantages of the invention will become better understood with reference to the following description, appended claims, and accompanying drawings.

### BRIEF DESCRIPTION OF THE DRAWINGS

FIG. 1 depicts a diagram of an embodiment of a system according to the current invention as it may exist in operation;

FIG. 2 depicts a diagram of an embodiment of a system according to the current invention as it may exist in operation;

FIG. 3 depicts a representative inventory item;

FIG. 4 depicts an embodiment of a shelf tag according to the current invention;

FIG. 5A depicts a representative shelf tag deployment within a facility;

FIG. 5B depicts an alternate representative shelf tag deployment within a facility;

FIG. 6 depicts a flowchart of an inbound inventory process according to the current invention;

FIG. 7 depicts a flowchart of an outbound inventory process according to the current invention;

FIGS. 8A and 8B depicts a housing configuration of an embodiment of a system according to the current invention;

FIGS. 8C and 8D depicts the housing configuration of FIGS. 8A and 8B in various states;

FIGS. 9A and 9B depicts an alternate housing configuration of an embodiment of a system according to the current invention;

FIG. 10 depicts a housing configuration as it may exist in usage;

FIG. 11 depicts a side perspective view of a diagram of an embodiment of a system according to the current invention as it may exist in operation;

FIG. 12 depicts a top view of a diagram of an embodiment of a system according to the current invention as it may exist in operation;

FIGS. 13A and 13B depict a top view of a diagram of an embodiment of a system according to the current invention as it may exist in operation;

FIG. 14 depicts an embodiment of a process for controlling throughput of messages;

FIG. 15 depicts a diagram of messages broadcast timing;

FIG. 16 depicts a diagram of broadcast channels in the Bluetooth protocols;

FIGS. 17A-17D illustrate representative advertising sequences;

FIGS. 18A-18C illustrate representative shelf tag to shelf tag hub communication sequences;

FIG. 19 illustrates a representative broadcast packet; and

FIG. 20 illustrates an embodiment of a process a processing a packet.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

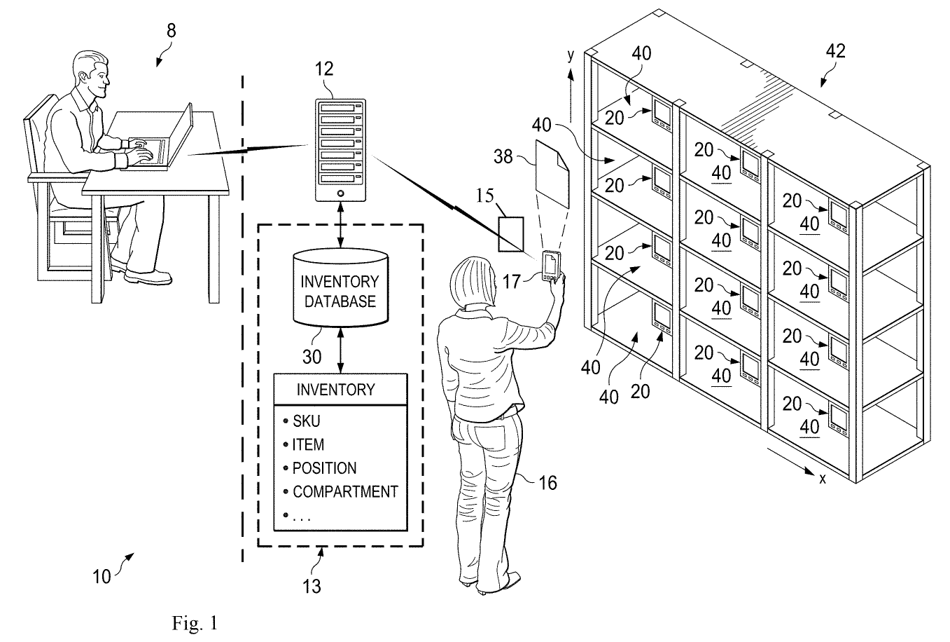

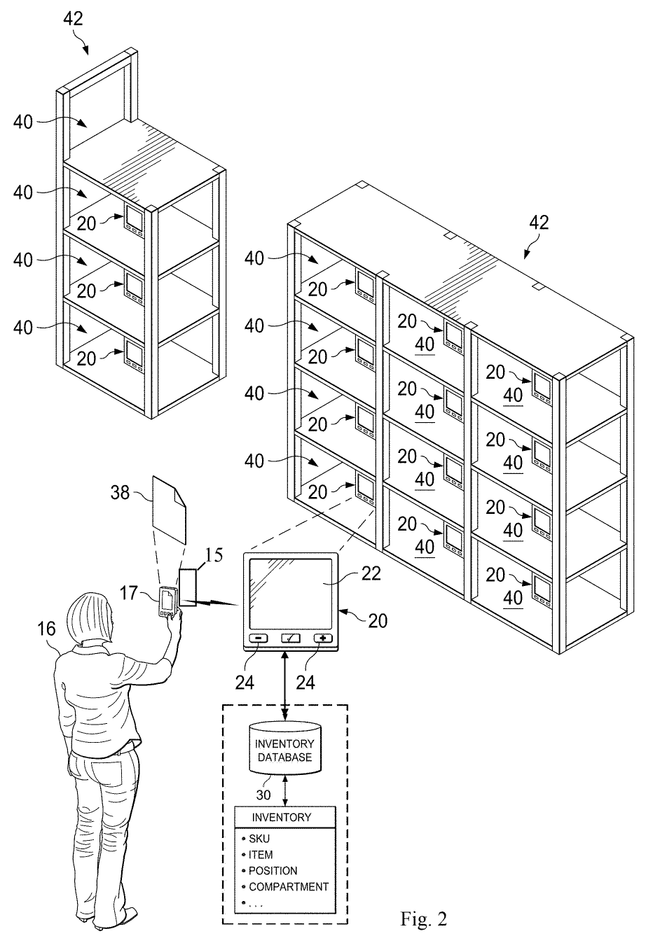

The current invention is directed to apparatus, systems, and methods of a shelf tag for use in inventory picking and inventory tracking. FIGS. 1 and 2 depict a block diagram of embodiments of systems according to the current invention as it may exist in operation, where a customer 08 initiates an order 38 to the system for processing. The depicted system includes a server 12 having a server module 13 which includes an inventory database 30. The inventory is stored on shelving 42 within the facility. Shelf tags 20 are disposed at defined regions 40 within the shelving 42. A worker 16 employs a portable computer 17 having a server module 15 to facilitate picking the inventory.

Shelving 42 is operable to store inventory, such as pallets, carton, boxes, or the like. Common shelving 42 includes multiple parallel vertical levels having a configured height, where inventory may be stored on each vertical level. Each vertical level has a total width x. The shelving 42 is segmented into defined regions 40. As illustrated, each vertical level is further divided horizontally to present a plurality of compartments 40. As used within this specification, each compartment 40 is defined region 40, although virtual or physical segmenting of shelving 42 is within the scope of this invention for a defined region 40. That is to say that the virtual segmenting may or may not coincide with the physical segmenting. Each compartment 40 has a defined width, height, and depth. It should again be noted that FIG. 2 is not to scale and that various shelving 42 can be placed within the facility spaced apart at varying distances causing workers to traverse various walkways 04 to access the necessary compartments 40.

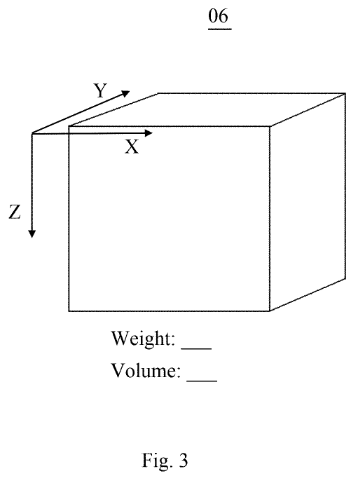

FIG. 3 illustrates a representative inventory item 06. Inventory items 06 can include items such as finished goods (those goods ready for sale to customers), work in process (materials and components that have begun their transformation to finished goods), raw materials (materials and components scheduled for use in making a product), or other goods. The items may be boxed, loose, or in other forms. Particular inventory items can have a given area, volume, weight, weight per unit volume, or other associated dimensional or weight measures. Distinct inventory items can have inventory identifiers such as stock keeping unit (SKU) or other identifier known in the art.

An illustrated embodiment includes a server 12. In exemplary configuration, a server module 13 is disposed on the server 12. The server 12 is a computer operable to carry out the instructions of the server module 13, process orders 38, and other operations. As used in the present disclosure, the term computer is intended to encompass any suitable processing device. For example, although FIG. 1 illustrates a single server 12, the environment may be implemented using one or more servers 12, including a server pool. Indeed, a server and client system may be any computer or processing device such as, for example, a blade server, general-purpose personal computer (PC), Macintosh, workstation, UNIX-based workstation, mobile phone, tablet, or any other suitable device. In other words, the present disclosure contemplates computers other than general purpose computers, as well as computers without conventional operating systems.

The computer includes a processor and memory for storing data and program instructions. Memory may include any memory or database and may take the form of volatile or non-volatile memory including, without limitation, magnetic media, optical media, random access memory (RAM), read-only memory (ROM), removable media, or any other suitable local or remote memory component. Memory may store various objects or data, including source code, object code, classes, applications, databases, repositories storing inventory, shelving, and any other appropriate information including any parameters, variables, algorithms, instructions, rules, constraints, or references thereto associated with the purposes of server 12. Further, a computer may be adapted to execute various operating systems, including Linux, UNIX, Windows, Mac OS, or other suitable operating system.

Server 12 is one that stores one or more applications, where at least a portion of the applications may be hosted applications executed via requests and responses sent to users or clients and communicably coupled to the illustrated environment of FIG. 1. In some instances, the server 12 may comprise a web server or be communicably coupled with a web server accessed and operated over network 18.

The portable computer 17 is a computer, as previously disclosed, with a portable form factor that can be readily moved about a facility, such as a tablet or smartphone. In exemplary configuration, a portable computer module 15 is disposed on a portable computer 17. In exemplary operation, a portable computer module 15 is assigned an identifier and associated with a worker 16.

In exemplary configurations, the system includes specialized storage in the form of an inventory database 30 configured to store inventory and shelving 42 description data. In exemplary configuration, shelving content data, inventory data, user data, are received and stored. One skilled in the art would appreciated that the data may reside in one or more databases, tables, or computers. Representative suitable database systems include MySQL, PostgreSQL, SQLite, Microsoft SQL Server, Oracle, or dBASE. In certain configurations, the inventory database 30 or portions thereof are distributed or synchronized.

In preparation for runtime, the inventory database 30 in memory is initialized and populated. Exemplary databases include a table having rows, “slices,” or other data structures or formats created to store the inventory data. Based on the received shelving configuration, the databases are initialized and pre-populated. General shelving 42 information such as the x axis minimum position, the x axis maximum position, the y axis minimum position, and the y axis maximum position are received and stored. Compartment 40 identifiers are assigned, and the compartment 40 identifier, compartment 40 position, and compartment 40 dimensions, and other information is stored.

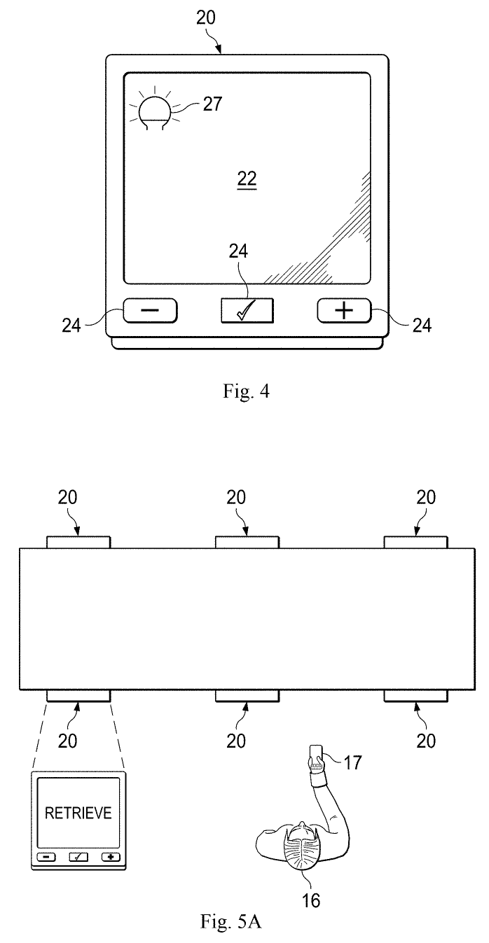

FIG. 4 illustrates a representative shelf tag 20. Certain embodiments of systems include one or more shelf tags 20 for association with a compartment 40 of the shelving 42. Each shelf tag 20 is secured to a compartment 40 and paired with the compartment 40. An exemplary shelf tag 20 includes a processor, memory, network adapter, a screen 22, and inputs 24, and a fastener 68 enclosed in housing. A suitable network adapter is wired or wireless one, enabling communication with the server 12, a worker's portable computer 17, or other shelf tags 20. The screen 22 is operable to display output from the shelf tag 20. The shelf tag 20 fastener 68 is operable to secure the shelf tag 20 to the associated compartment 40. Suitable fasteners 68 include hook and loop, standoffs, hangers, and the like.

Communication among computers 12 17 and shelf tags 20 is facilitated by a network 18. Network 18 may also include one or more wide area networks (WANs), local area networks (LANs), personal area networks (PANs), mesh networks, all or a portion of the Internet, and/or any other communication system or systems at one or more locations. Network 18 may be all or a portion of an enterprise or secured network, while in another instance at least a portion of the network 18 may represent a connection to the Internet. Further, all or a portion of network 18 may comprise either a wireline or wireless link. In other words, network 18 encompasses any internal or external network, networks, sub-network, or combination thereof operable to facilitate communications between various computing components inside and outside the illustrated environment. The network 18 may communicate by, for example, Bluetooth, Zigbee, WiFi, cellular, Internet Protocol (IP) packets, Frame Relay frames, Asynchronous Transfer Mode cells, voice, video, data, and other suitable information between network addresses. Various communications can occur over the network 18. For example, a server 12 may directly communicate with a shelf tag 20, a server 12 may directly communicate with a portable computer 17, a portable computer 17 may directly communicate with a shelf tag 20, a server 12 may communicate with a shelf tag 20 with a portable computer 17 as an intermediary.

Certain embodiments implement a modified version of the Bluetooth and/or Bluetooth Low Energy protocols. Select extracts of the Bluetooth protocol are annexed and incorporated by reference. Bluetooth low energy employs two multiple access schemes: Frequency Division Multiple Access (FDMA) and Time Division Multiple Access (TDMA). Forty physical channels, separated by 2 MHz, are used in the FDMA scheme. Three of these channels are used as advertising channels, and the remaining 37 are used as data channels. The physical channel is sub-divided into time units known as events. Data is transmitted between low energy devices in packets that are positioned in these events. There are two types of events: advertising and connection events. The advertising channel carries the device's discovery and connection establishment information. After a connection is established, a data channel provides link control data and payload for higher level protocols and further action.

In common operation, a shelf tag 20 acts as an advertiser and a server 12, portable computer 17, or another shelf tag 20 act as the receiver. Bluetooth devices use the advertising procedure and scanning procedure to discover nearby devices, to be discovered by devices in a given area, or to form a connection with another Bluetooth device. The discovery procedure and connection procedure are both asymmetrical. A first Bluetooth device needs to listen for devices advertising scannable or connectable advertising events, while another Bluetooth device is actively broadcasting scannable or connectable advertising events over the advertising broadcast physical channel. An advertisement transmission has a minimum transmission time of about 3 milliseconds.

Advertising intervals can be set in a range of 20 milliseconds to 10 seconds. It specifies the interval between consecutive advertising packets. The existing Bluetooth protocol employs a common advertising interval for devices in the same environment, limiting the number of successful connections where there are a high number of advertisers, without resorting to retransmission, which requires additional power or CPU cycles. Certain configurations of the current invention employ a varying advertising interval for the shelf tags 20 in the same environment. More specifically, among a plurality of shelf tags deployed to an environment, a first shelf tag 20 or set of shelf tags 20 are configured with a first configured advertising interval and a second shelf tag 20 or set of shelf tags 20 are configured with a second advertising interval, resulting in effective prioritized connections without additional battery or CPU cycles.

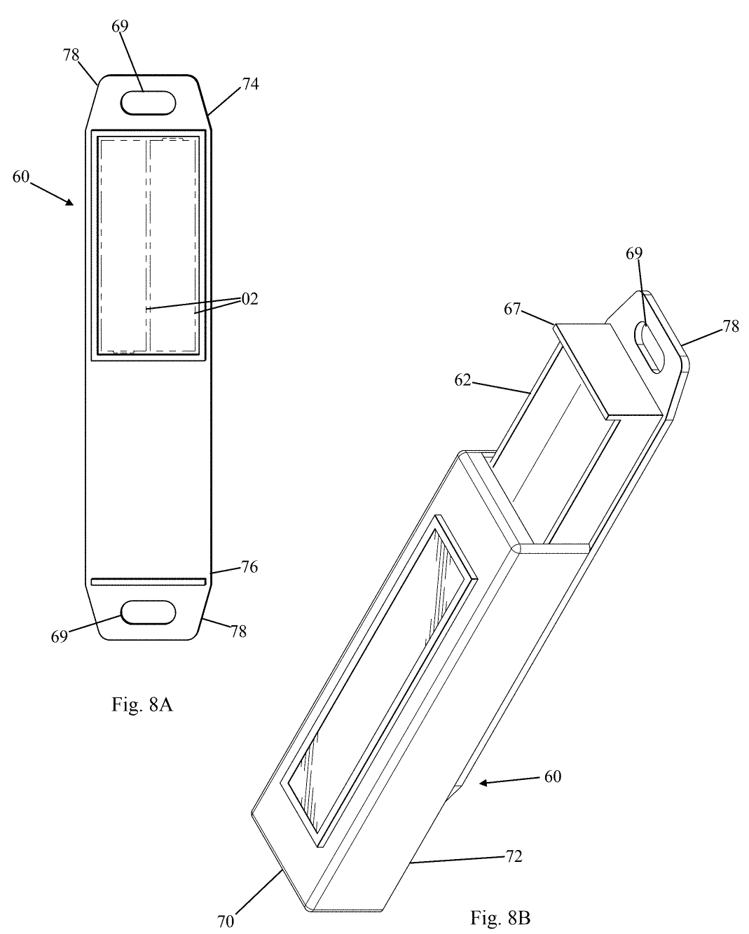

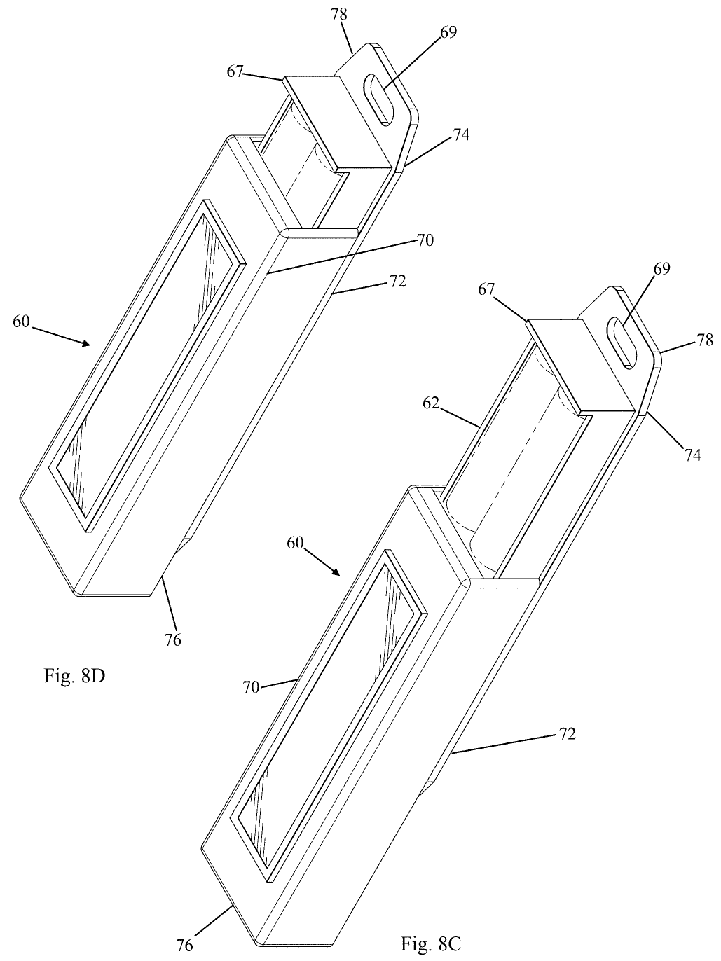

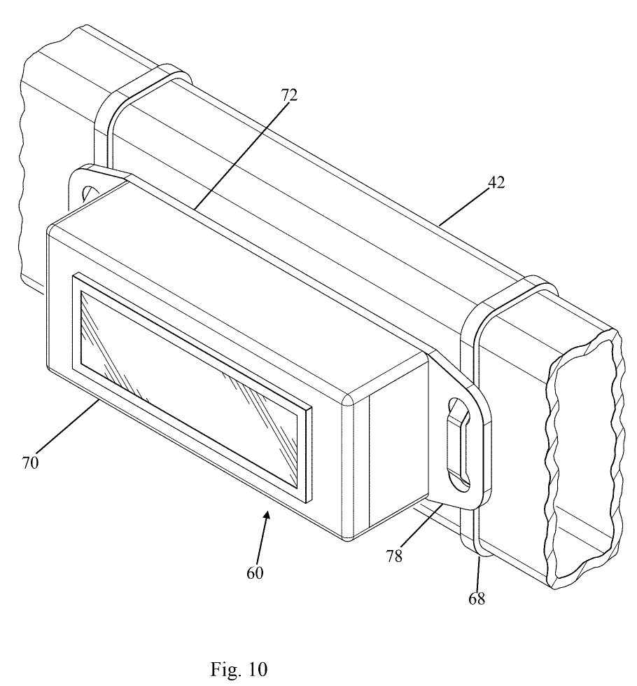

Certain embodiments of the shelf tags 20 are powered by batteries. In certain configurations, the battery level is transmitted by the shelf tag 20 over the network. Certain embodiments of the shelf tag 20 include a housing 60 arrangement for battery access. FIGS. 8A-8D illustrate a first housing 60 configuration. The housing 60 has an upper portion 70, a lower portion 72, a proximal end 74, and a distal end 76. The housing 60 bounds an interior section of the shelf tag 20. The housing 60 further includes a tray 62 dimensioned for slidable travel from the proximal end 74 of the housing 60 to the distal end 76 of the housing 60. The tray 62 includes a recess dimensioned for receipt of one or more batteries 02. The tray 62 optionally further includes an access tab 67 on its proximal end 74. The proximal end 74 of the housing 60 includes a flange 78 on the extending outwardly and from the lower end 72 of the housing 60, whereby the tray 62 may slidably travel past it. The housing 60 includes a mount 69 in the lower section 72 of the housing 60 for receipt of a fastener 68. The illustrated mount 69 is an aperture disposed in the flange 78. In use of this housing 60 configuration, the user inserts batteries 02 in the recess of the tray 62 and pushes the access tab 67 such that the tray 67 slides from the open position of FIG. 8C to the position of FIG. 8D to a completely closed position. FIG. 10 shows the housing 60 mounted to shelving 42 with a fastener 68 applied to the mount 69.

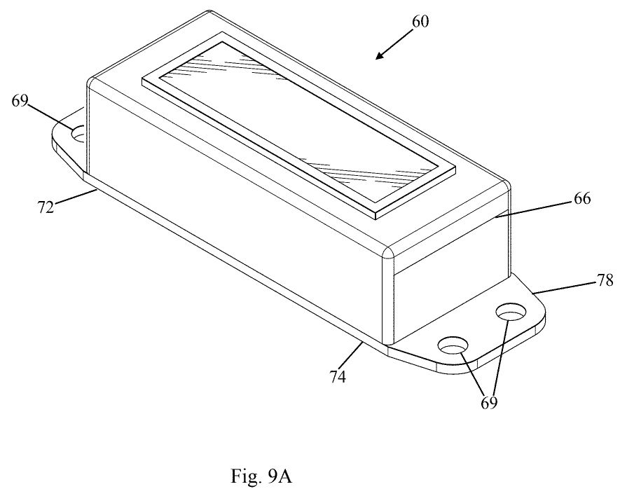

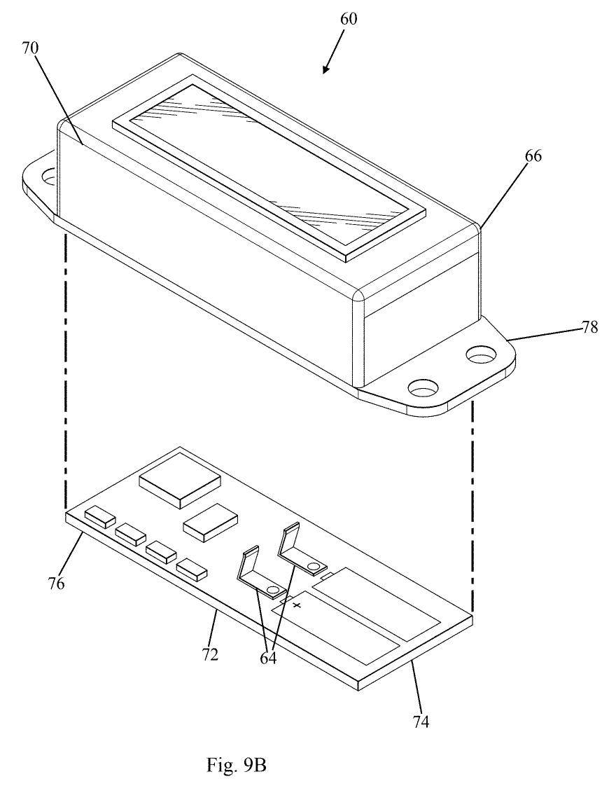

FIGS. 9A and 9B illustrate a second housing 60 configuration. The housing 60 has an upper portion 70, a lower portion 72, a proximal end 74, and a distal end 76. The housing 60 bounds an interior section of the shelf tag 20. The interior section of the housing 60 is dimensioned for receipt of one or more batteries 02. The interior section of the housing 60 further includes one or more secured spring contacts 64. The spring contacts 64 are tension biased, providing an opposing force to a battery 02 in contact with it. The housing 60 further includes a removable access door 66 on its proximal end 74. The proximal end 74 of the housing 60 includes a flange 78 on the extending outwardly and from the lower end 72 of the housing 60, whereby the access door 66 may slidably travel past it. The housing 60 includes a mount 69 in the lower section 72 of the housing 60 for receipt of a fastener 68. The illustrated mount 69 is an aperture disposed in the flange 78. In use of this housing 60 configuration, the user inserts batteries 02 in the interior section of the housing 60, engaging the battery 02 pole against the spring contact 64, loading it, and engages the access door 66 to enclose the battery 02 therein. FIG. 10 shows the housing 60 mounted to shelving 42 with a fastener 68 applied to the mount 69.

In certain embodiments, the processor of the shelf tag 20 is implemented with an instruction set for picking and inventory operations. Representative instructions include, but are not limited to, increment local inventory, decrement local inventory, transmit local inventory count, display local inventory count, and display pick indicator alerts.

The illustrated shelf tag 20 includes a user interface 24 for worker 16 interaction, such as picking and inbound or outbound inventory operations. The user interface comprises may include a plurality of configurable customizable frames or views having interactive fields, pull-down lists, and buttons operated by the user. For example, the user interface may provide interactive elements that allow a user to select from a list of commands, descriptors, or attributes for input into a data field displayed in it. The user interface contemplates any suitable user interface, such as a combination of a text interface, web browser, and command line interface that processes information in the platform and efficiently presents the results to the user visually. An exemplary user interface includes a pick indicator 27. The pick indicator 27 is an element which indicate pick activity to the worker 16 at the compartment 40 with which the shelf tag 40 is associated. Representative suitable pick indicators 27 include a display, light, speaker, or other pick indicators, enabling light signals, text messages, insignia messages, flash sequences, video messages, audio messages, and other pick indicator messages. Representative light messages include turning on or off, different colors, or a flash sequence. Representative text messages include an inventory identifier such as a SKU and quantity. Representative video or insignia messages include a depiction of the inventory. Representative audio messages include an inventory identifier such as a SKU and quantity.

A pick indicator 27 is activated in response to a control signal from the server module 13. In other configurations, a pick indicator 27 is activated in response to a control signal from the portable computer module 15. It should be understood that certain processes within this specification can be performed by either the server module 13 or the portable computer module 15. The control signal can include pick indicator 27 instructions and display information. In certain configurations, a control signal includes an on/off signal. In certain configurations, a control signal includes pick indicator message text for display.

An exemplary user interface 24 includes button inputs 24 which provide confirmation of inbound inventory and outbound inventory. The illustrated input buttons 24 set includes an inventory increment button 24 (shown as “+”), an inventory decrement button 24 (shown as “−”), and a confirm pick button 24 (shown as check mark). Upon worker 16 engagement with the inputs 24, the shelf tag 20 stores the event input. In certain configurations, the local inventory count is incremented or decremented in local memory, such as a local portions of the inventory database 30, or the input is transmitted to the server 12 for inventory updates to the inventory.

The local inventory database 30 or portions thereof may be queried via the user interface 24, via a portable computer 17, via the server 12, or other computers over the network. For example, server 12 may synchronize with the local inventory database 30 of the shelf tag 20. In certain configurations, the server 12 directly synchronizes with the shelf tag 20. In other configurations, the server 12 synchronizes with the shelf tag 20, with the portable computer 17 as an intermediary. In certain configurations, the synchronization is bi-directional. In other configurations, the server 12 data of the inventory database 30 is the master copy or the shelf tag 20 data of the inventory database 30 is the master copy. The server 12 may query one or more local inventory databases 30 of shelf tags 20 for comparison with its inventory database for the compartment for inventory analysis, shrinkage analysis, and the like. It is within the scope of this invention to trigger synchronization upon inventory addition or removal from the compartment 40, upon interaction with a portable computer module 15, upon interaction with a server module 15, upon a configured time or interval, or other suitable triggers.

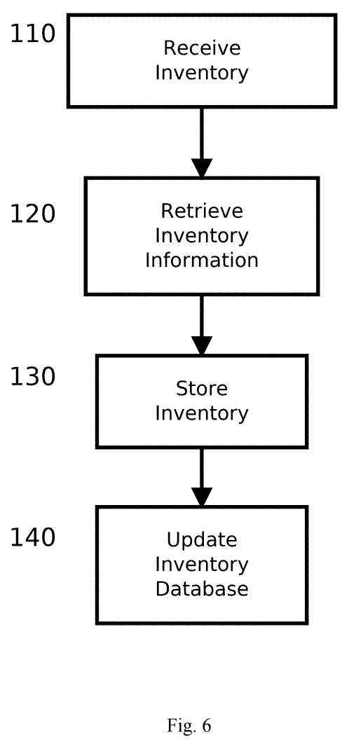

The system is setup for operation. FIG. 6 depicts an exemplary process for inbound inventory processing. At step 110 inventory is received at the facility. At step 120, the inventory type is information received. At step 130, the inventory is placed on the shelving. At step 140, the inventory database is updated. More consideration will be given to each of the steps below.

The shelving 42 is deployed in the facility. A particular facility will have a need for a number of units of storage for a particular location. Accordingly, it will deploy a selected number of shelves 42 having a selected number of vertical levels, a selected number of horizontal columns, and a compartment 40 volume. The system is deployed to the facility. The inventory database 30 is initialized, with the shelving compartment 40 identifier, compartment 40 positions, compartment 40 dimensions, inventory identifiers, and other information being stored. A shelf tag 20 is deployed to each compartment 40. The shelf tag 20 to compartment 40 association is stored in the inventory database 30.

At step 110 inventory is received at the facility. The inventory is segregated by type. At step 120, the inventory identifiers are type(s) retrieved for each type of inventory. The designated compartment 40 for the inventory identifiers is retrieved. In certain processes, volume or weight measure of the particular inventory is received and stored. At step 130, the inventory is placed in the shelving 42 in the compartments 40 designated for the corresponding inventory identifier. At step 140, the local inventory count is updated.

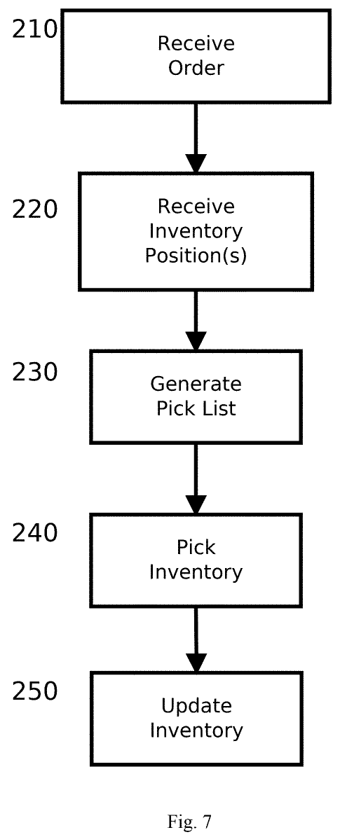

FIG. 7 depicts an exemplary process for outbound inventory processing. At step 210, an order is received. At step 220, the inventory positions for the order are received. At step 230, the pick list is generated. At step 240, the inventory is picked. At step 250, the inventory database is updated. More consideration will be given to each of the steps below.

At step 210, an order requesting merchandise is received. A customer 08 places an order over the network 18. The order 38 includes a list of items requested from inventory. At step 230, the pick list 38 is generated. As illustrated, the pick list is the same as the order 38. The order 38 contains the quantity and item type of inventory to be retrieved.

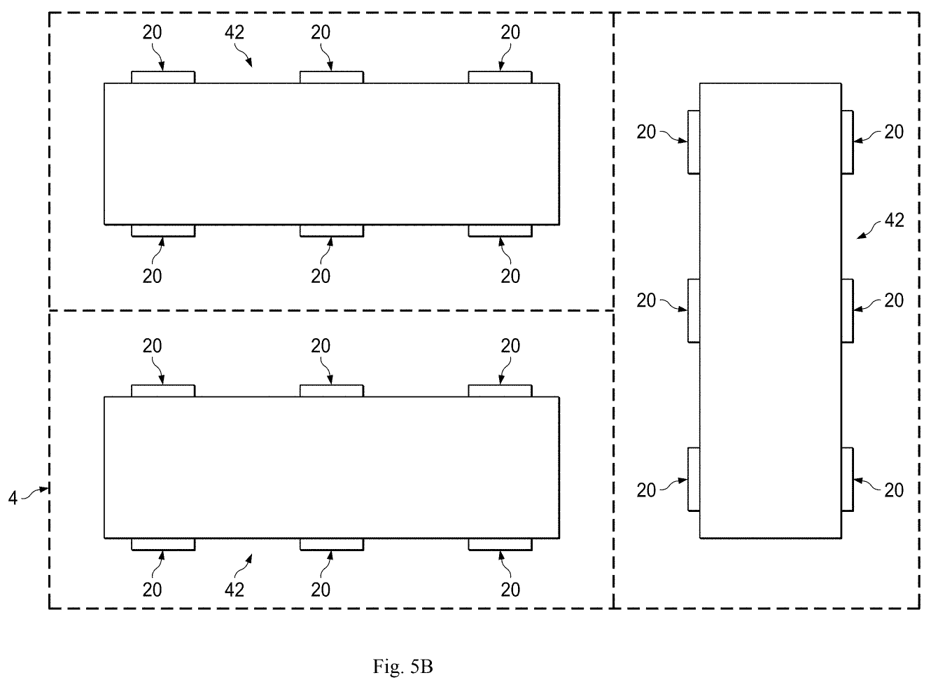

At step 220, the positions for the items in the order 38 are received. The server module 13 retrieves the order 38 and parses the items and retrieves the associated item identifiers from the inventory database 30. The server module 13 further retrieves the compartment 40 information for the associated item identifiers, including the compartment 40 position. In certain configurations, the weight and/or volume measures are retrieved for the associated item identifiers and displayed individually or in total. To illustrate, the calculate the total volume of an order for display to a worker 16 or calculate the total weight of an order for display to a worker 16. In certain configurations, display is conditioned upon a threshold volume or weight. The server module 13 transmits the compartment 40 position to the portable computer module 15 receiving the order 38. The server module 13 transmits or portable computer module 15 transmits control signals to the shelf tags 20 corresponding to the compartment 40 having the associated item identifiers for the order 38. In response, the shelf tag 20 activates the pick indicator 27, as illustrated in FIGS. 3 and 5B. Exemplary pick indicators 27 alerts are customized according to the identifier of the portable computer module 15. For example, where the pick indicator 27 is a light, the pick indicator 27 message's color or flash sequence may be unique to the portable computer module 15 associated with the order 38. For example, where the pick indicator 27 message is a text message, the pick indicator 27 message's text message may be unique to the portable computer module 15 associated with the order 38. It can include retrieval instructions such as “SKU nnn, retrieve n items.”

At step 240, the inventory is picked. After the worker 16 removes the inventory from the compartment 40, the worker 16 presses the inventory pick confirmation button 24, updating the local inventory count. Periodically, the local inventory count may be compared with the remote inventory count.

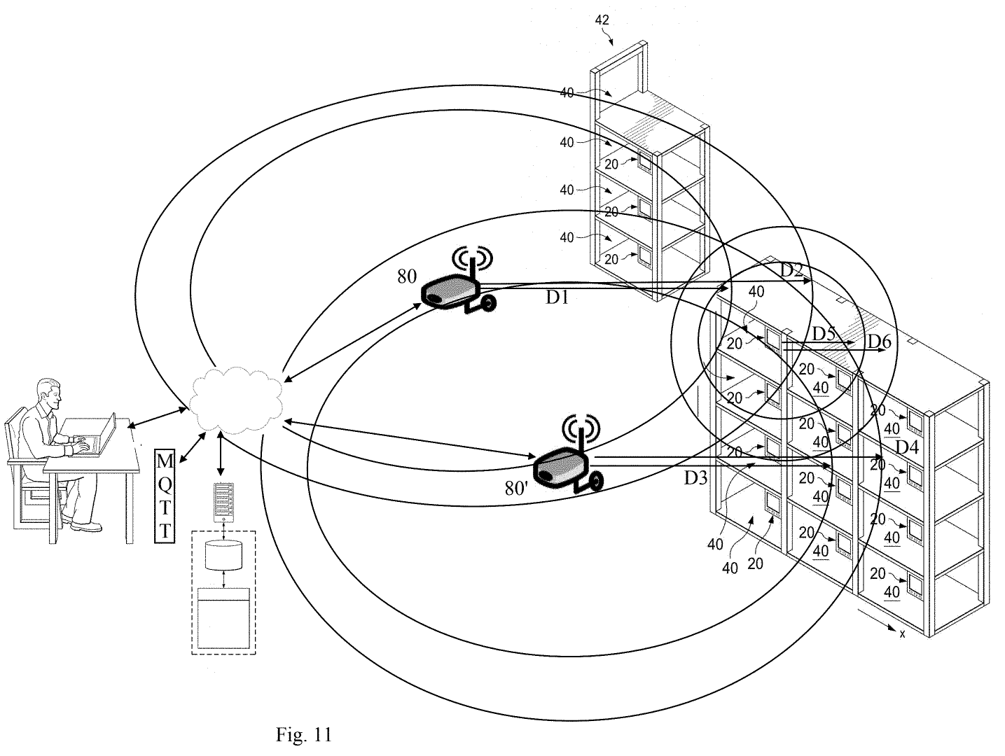

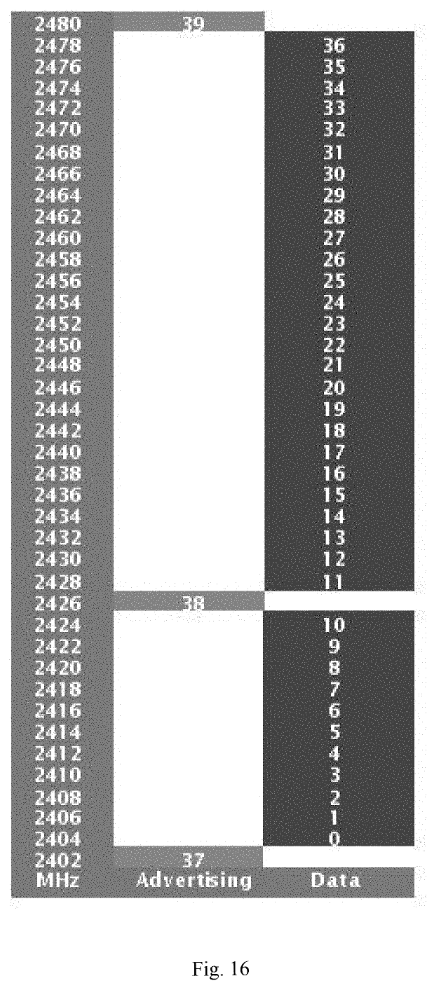

As illustrated in FIGS. 11-19, as previously disclosed, certain embodiments of the invention employ modified versions of the Bluetooth and/or Bluetooth Low Energy protocols (collectively referred to as the Bluetooth protocols). As shown in FIG. 16, in the base Bluetooth protocols, Bluetooth Low Energy employs two multiple access schemes: Frequency Division Multiple Access (FDMA) and Time Division Multiple Access (TDMA). Forty physical channels, separated by 2 MHz, are used in the FDMA scheme. Three of these channels are used as advertising channels, and the remaining 37 are used as data channels. The physical channel is sub-divided into time units known as events. Data is transmitted between low energy devices in packets that are positioned in these events. There are two primary types of events: advertising and connection events. The advertising channel carries the device's discovery and connection establishment information. After a connection session is established, a data channel provides link control data and payload for higher level protocols and further action.

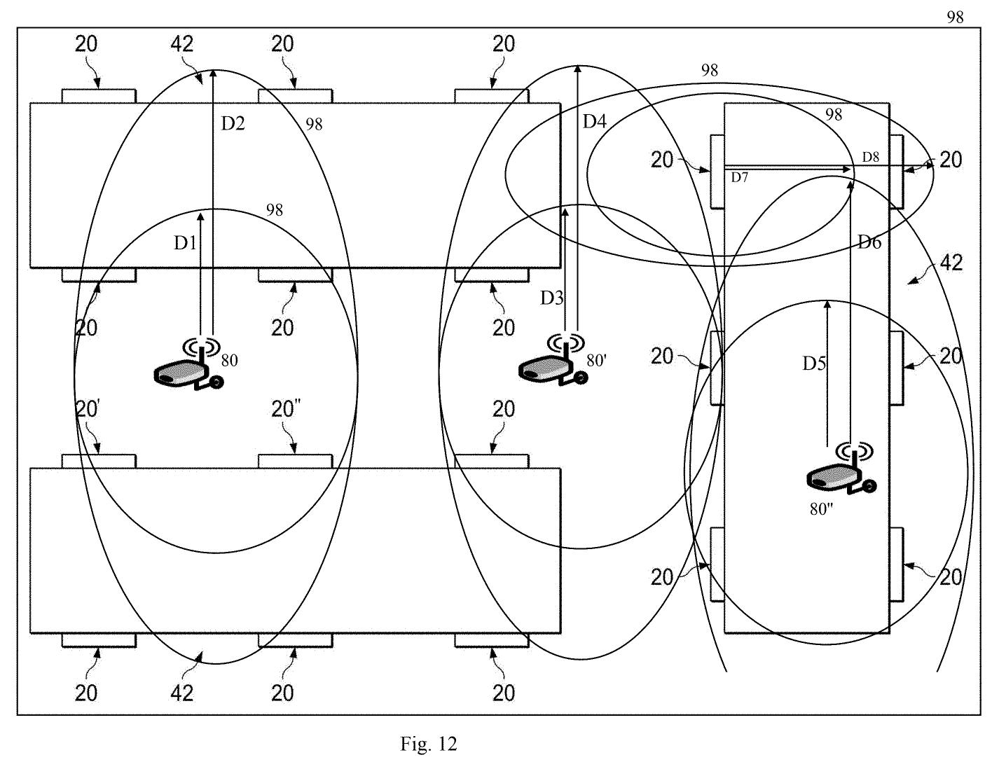

Certain embodiments of systems include a shelf tag hub 80. FIGS. 11 and 12 illustrate representative shelf tag hubs 80 as they may exist in operation. Shelf tag hubs 80 are deployed to an area having shelf tags 20 for wireless communication with them. Each shelf tag hub 80 has a transmission region 98 where shelf tags 20 may be deployed therein. An exemplary shelf tag hub 80 includes a processor, memory, and one or more network adapters in housing. Certain embodiments of the shelf tag hub 80 include a first network adapter for communication with the server 12 or a worker's portable computer 17 and a second, wireless adapter for communication with shelf tags 20 or other shelf tag hubs 80. One or more shelf tag hubs 80 may be deployed within shelving areas for a larger transmission region 98.

In certain embodiments, the shelf tag hubs 80 are configured with a modified Bluetooth protocol. In common operation, a shelf tag 20 acts as an advertiser and a shelf tag hub 80 acts as a receiver. In base Bluetooth protocol, Bluetooth devices use the advertising procedure and scanning procedure to discover nearby devices, to be discovered by devices in a given area, or to form a connection with another Bluetooth device. A first Bluetooth device listens for devices advertising scannable or connectable advertising events, while another Bluetooth device is actively broadcasting scannable or connectable advertising events over the advertising broadcast physical channel.

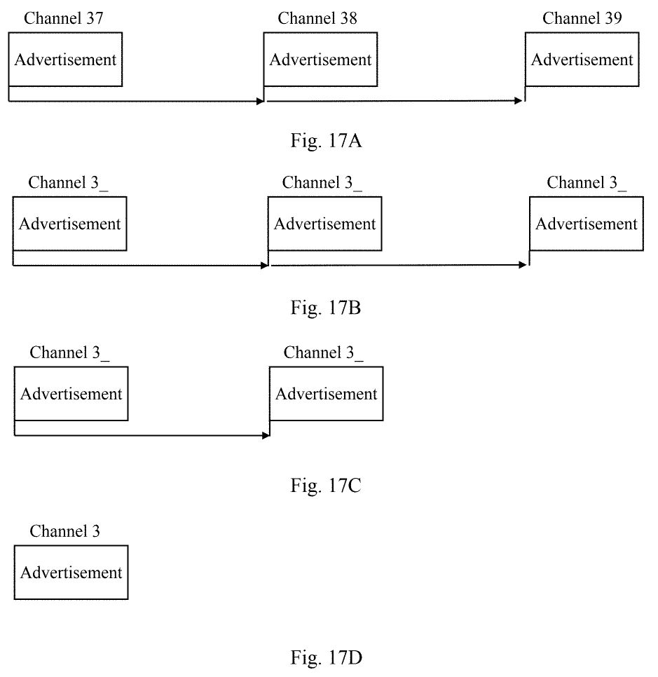

In certain embodiments, the modified Bluetooth protocol includes modifications where the advertisements serve as a basis of shelf tag 20 to shelf tag hub 80 messaging. FIGS. 17A-17C illustrate various represent communication flows between shelf tag hubs 80 and shelf tags 20. FIG. 17A illustrates a sequence where a shelf tag 20 wakes, transmits a message over an advertisement, and terminates the communication session. FIG. 17B illustrates a sequence where a shelf tag 20 wakes, listens for a message for a period, then sleeps. FIG. 17C illustrates a sequence where a shelf tag 20 wakes, listens for a message for a period, and during that period the shelf tag hub 80 transmits a message for processing by the shelf tag 20.

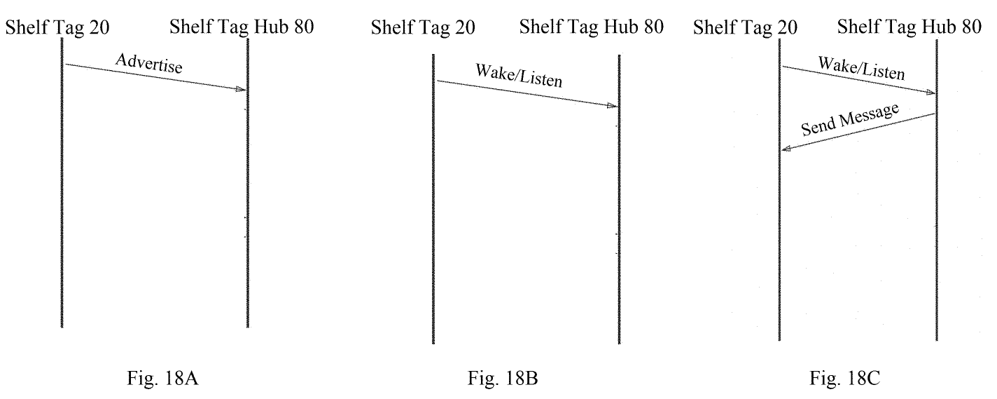

As previously disclosed, an object of shelf tag 20 communication with shelf tag hubs 80 is communication of messages 90. FIG. 18 illustrates various message 90 content. Various messages 90 include communication of inventory information, inventory data commands, signals to inventory workers 16, device 20 80 state information for facilitating communications, message types or categories, message integrity information, message ordering, message timing, and other content.

One object of embodiments of the invention includes communication to a plurality of shelf tags 20 in a warehouse area. With a plurality of workers 16, shelf tag hubs 80, and shelf tags 20, it is desirable to optimize transmission throughput of messages 90 in shelf tag hub 80 and shelf tag 20 communications, as signal collision can occur when multiple devices attempt to transmit a signal along the same transmission channel. Signal collision can lead to packet delays or packet corruption.

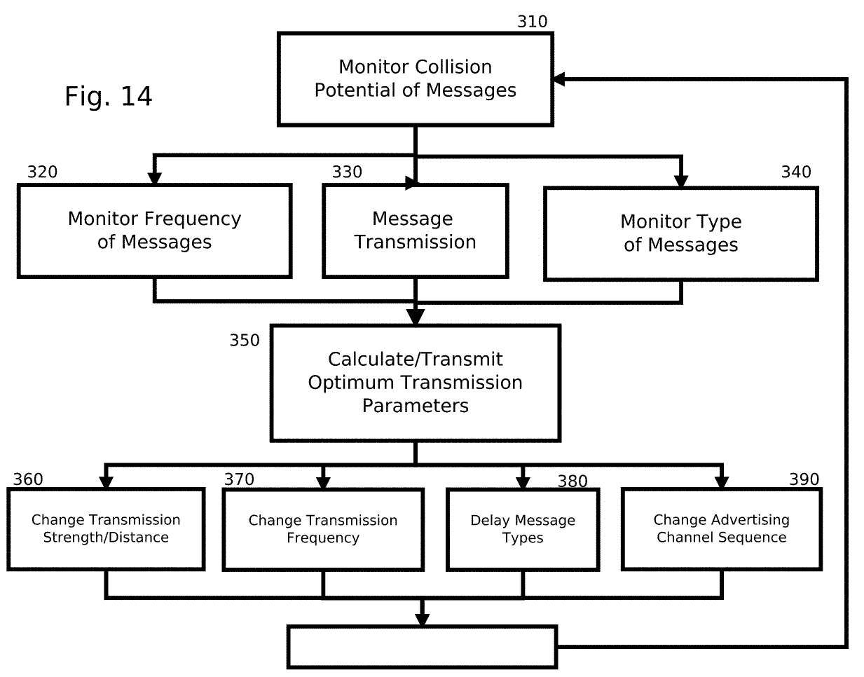

FIG. 14 illustrates an embodiment of a process to optimize communication throughput of packets, and, in turn, messages 90. A server 17, shelf tag hub 80, or shelf tag may receive or monitor one or more of the inputs for optimum transmission parameters. The system monitors the collision potential of messages being transmitted in the transmission area using various factors as input and processes to minimize signal collision 310. The system monitors for collision potential of messages 90 within a transmission region 98. That transmission region 98 might be one for one or building, one or more a shelf tag hubs 80, and/or one or more shelf tags 20.

As a basis for input, volume of messages 90 within a selected time window for a transmission region 98 is received 320. Historical, contemporaneous, or projected message 90 volume may be employed. For example, current requests 38 for goods within a building transmission region 98 may be employed as a basis for message 90 volume. For example, current requests 38 for goods within a shelf tag hub 80 transmission region 98 may be employed as a basis for message 90 volume. For example, current requests 38 for goods within a shelf tag 20 transmission region 98 may be employed as a basis for message 90 volume.

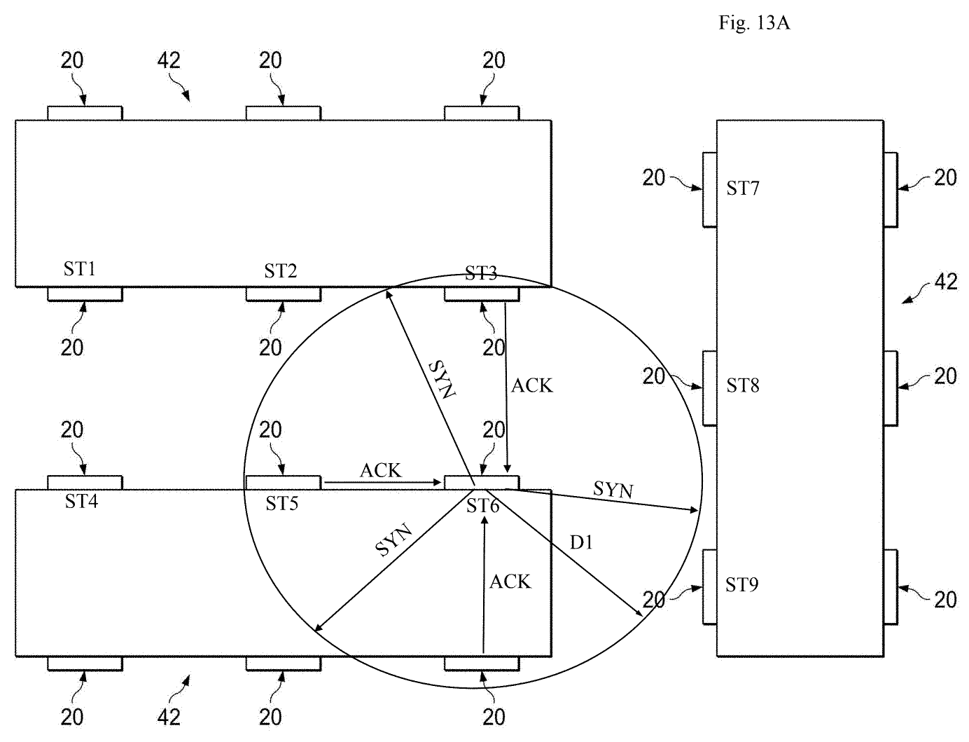

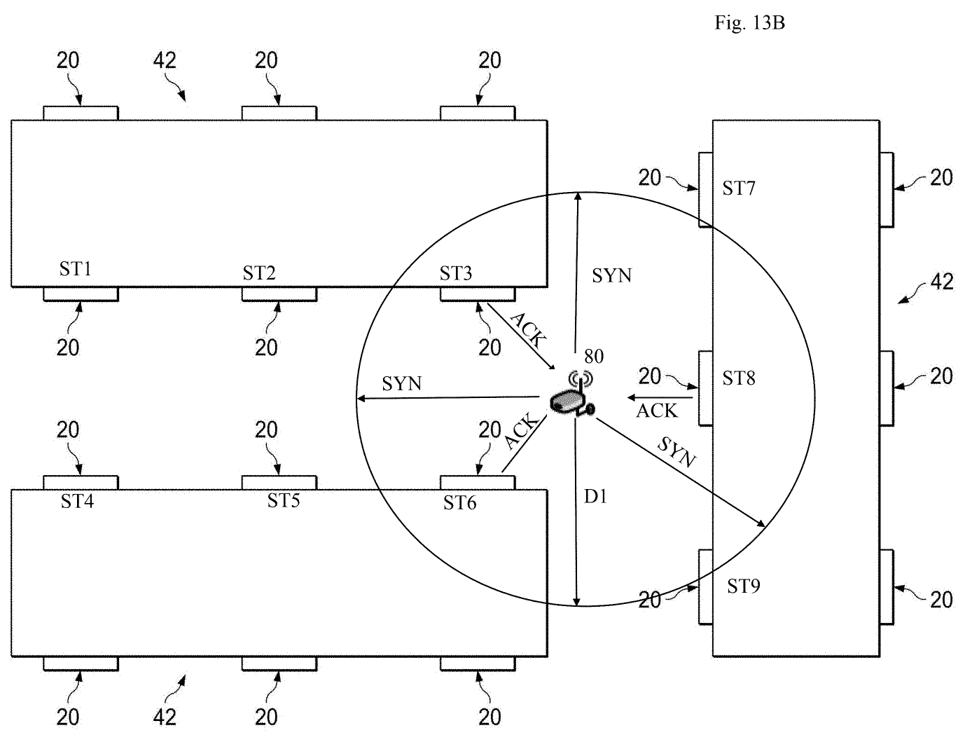

FIGS. 13A and 13B indicate a further basis for monitoring the frequency collision potential of messages within a transmission region 98. The figures show a source transmitter, a shelf tag 20 in FIG. 13A and a shelf tag hub 80 in FIG. 13B, transmitting a broadcast (SYN) at a known signal strength from its position. Signal receiving devices within the transmission range D1 of that broadcast (SYN) respond (ACK), acknowledging the broadcast. The source transmitter processes the broadcast acknowledgements, using the acknowledgements as a basis for message 90 frequency potential, with a higher number of acknowledgements representing a higher risk of signal collision. In other configurations, the properties of the acknowledgements serve as further basis for signal collision risk. One such property is the received signal strength, which enables the source transmitter to determine relative mapping of the acknowledging devices. In other configurations, the broadcast (SYN)/respond (ACK) process is performed from multiple devices within the transmission region 98, successively or iteratively. To illustrate, a shelf tag hub 80 may initiate a broadcast (SYN)/respond (ACK) process and send an instruction to a shelf tag ST6 to initiate a broadcast (SYN)/respond (ACK) process and relay the results, with the iterative process enabling higher accuracy mapping, and in turn better determination of signal collision risk.

As a basis for input, the priority of message 90 content within a selected time window for a transmission region 98 is determined and assigned 340. Certain messages 90 or content therein can be assigned a priority. For instance, certain message 90 content can include pick indicator 27 instructions, where a worker 16 may be nearby. That message 90 content can be assigned a higher priority. For instance, certain message 90 content can include a firmware update instruction. That message 90 content can be assigned a lower priority.

At step 330, messages 90 are transmitted. In certain embodiments, processes to maintain packet integrity are employed or to determine packet integrity are employed. For instance, message 90 content can include a voltage indicator or cyclic redundancy check (CRC) data, which can indicate a higher risk of corrupt packet transmission. For instance, a shelf tag may communicate a message that a corrupt packet was received. As a basis for input, the number of actual corrupt packets within a selected time window may be employed. Messages 90 are transmitted and the risk of corrupt packet transmission or actual corrupt packet transmission frequency is monitored.

Using the input as basis, optimum transmission parameters are calculated and transmitted to devices 20 80 within the transmission region 350. A server 17, shelf tag hub 80, or shelf tag may calculate one or more of the optimum transmission parameters. Exemplary target transmission parameters are those which result in peak usage of channels with minimal collisions or collision risk and minimal delay. In certain configurations, target transmission parameters are those which result in peak utilization of channels. In certain configurations, target transmission parameters are those which result in minimal delay. In certain configurations, target transmission parameters are those which result in minimal collisions. One or more transmission parameters might be adjusted.

In certain embodiments, the transmission strength of a device 20 80 is changed in optimizing transmission parameters 360. FIGS. 11 and 12 illustrate shelf tag hubs 80 and shelf tag 20 of various transmission strengths as they may exist in operation. The system calculates an optimum transmission strength. In calculating an optimum transmission strength, a signal strength for a target transmission distance is calculated. A target transmission distance one which optimizes transmission parameters. For example, in order to decrease collision risk, the target transmission distance for a shelf tag hub 80 might be decreased from distance D2 to D1. For example, in order to decrease collision risk, the target transmission distance for a shelf tag 20 might be decreased from distance D2 to D1. When channel utilization is below a threshold, the target transmission distance for a shelf tag hub 80 might be increased from distance D3 to D4. It should be understood that the transmission distance may be optimized for both shelf tag hubs 80 and shelf tags 20. As illustrated, its should be understood that different devices 80 80′ 20 20′ 20″ can have different target transmission distances.

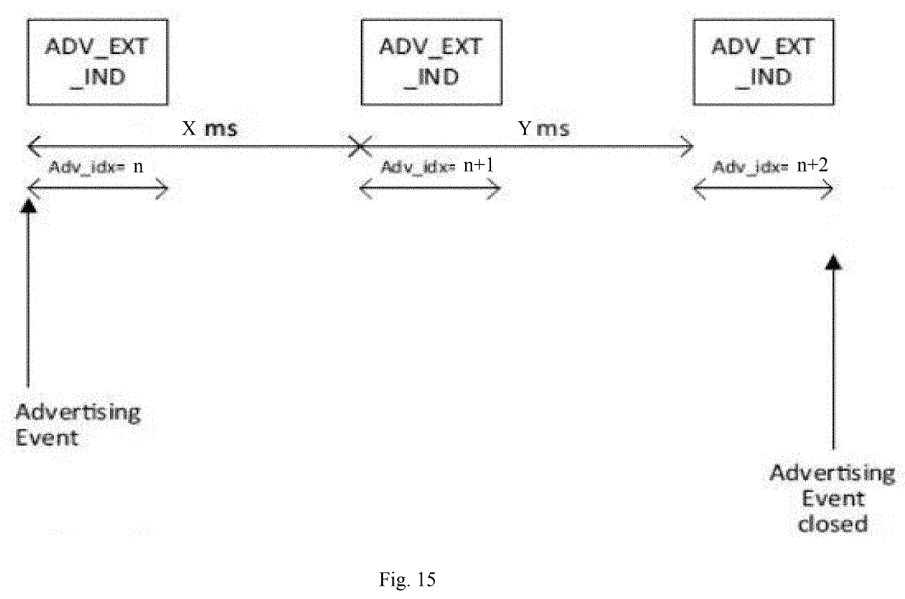

In certain embodiments, the packet frequency transmission of one or more devices 20 80 is changed in optimizing transmission parameters 370. FIG. 15 illustrates a sequence of packets transmitted by shelf tag hubs 80 or shelf tag 20 at various intervals. The system calculates an optimum packet frequency transmission interval. A target optimum packet frequency transmission interval is one which optimizes transmission parameters. For example, in order to decrease collision risk, the packet frequency transmission interval for a shelf tag 20 might be increased from time X to time Y. When channel utilization is below a threshold, the target packet frequency transmission interval for a shelf tag 20 might be decreased from time Y to time X. It should be understood that the packet frequency transmission interval may be optimized for both shelf tag hubs 80 and shelf tags 20. It should also be understood that different devices 80 80′ 20 20′ 20″ may have optimum packet transmission interval.

In certain embodiments, the advertising channel sequence of one or more devices 20 80 is changed in optimizing transmission parameters 390. Bluetooth low energy employs three channels, channel 37-39, as advertising channels and the remaining 37 are used as data channels. FIG. 17 illustrate various sequences of packets transmitted by shelf tag hubs 80 or shelf tag 20. The system calculates an optimum advertising channel sequence. A target optimum advertising channel sequence is one which optimizes transmission parameters. For example, in order to decrease collision risk, the system can assign the advertising sequence of FIG. 17A to a first group of shelf tags 20 within a shelf tag hub 80 transmission region and an alternate ordered three packet sequence of a different channel sequence, such as that of FIG. 17B, to a first group of shelf tags 20 within a shelf tag hub 80 transmission region. In other configurations, a one or two advertising channel sequence, such as that of FIGS. 17C or 17D, may be assigned to devices 20 80. Again, it should be understood that the advertising channel sequence may be optimized for both shelf tag hubs 80 and shelf tags 20. Again, it should also be understood that different devices 80 80′ 20 20′ 20″ within the same transmission region 98 can have different optimum advertising channel sequences.

In certain embodiments, lower priority message content 90 transmissions are delayed 380. As previously disclosed, a priority of message 90 content can be assigned. In this configuration, message transmission of messages 90 with a priority lower than a target threshold are delayed. For example, a shelf tag hub 80 may have two message enqueued for transmission, a first packet with message 90 content of a firmware update to a shelf tag assigned a low priority and a second packet with message 90 content of a pick indicator instruction assigned a high priority. In order to decrease collision risk, the shelf tag hub 80 transmission parameter may be set to delay low priority message transmission, resulting in delayed transmission of the first packet with firmware update message 90 content.

After the optimum transmission parameters are determined and transmitted, the system returns to monitoring for collision potential 310.

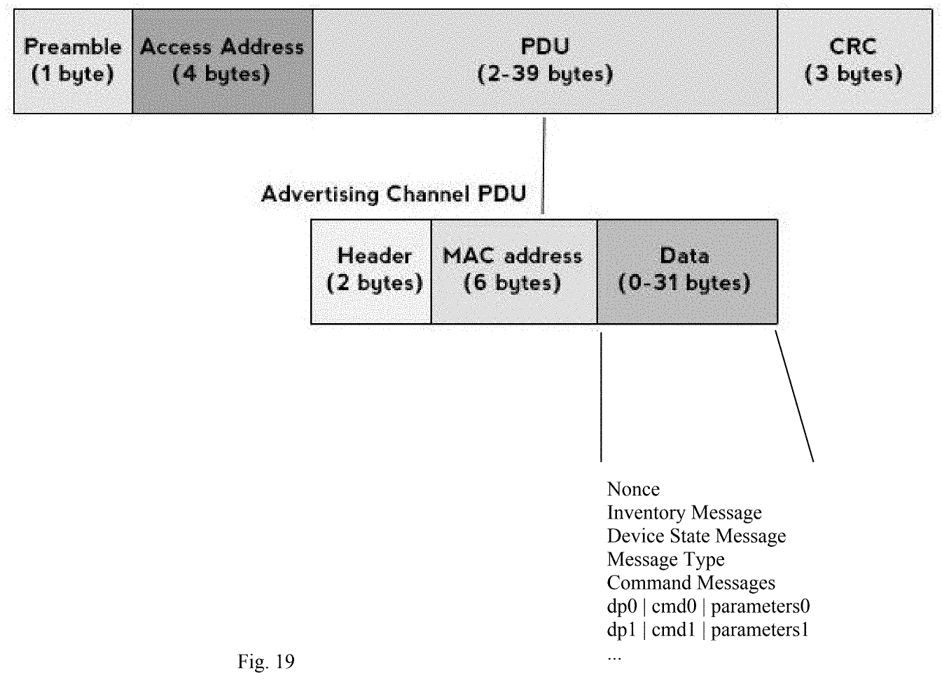

FIG. 19 displays a representative packet for transmission. Illustrated is a generic advertisement packet, though it is within the scope of the invention to employ other packet formats. The message 90 is included in the Advertisement Channel PDU data. The advertisement payload has 31 bytes that can include messages 90 for a number of different activities, such as inventory data, inventory commands, pick indicators, device state, and other inventory/communication/device data. Representative messages 90 include inventory count/type in the associated compartment, pick indicator instructions such as activating a light/sound, device state information such as voltage/uptime/firmware version, communication information such as message priority/message type/nonce, attached device information such as sensor data, and instruction sets for responding to commands.

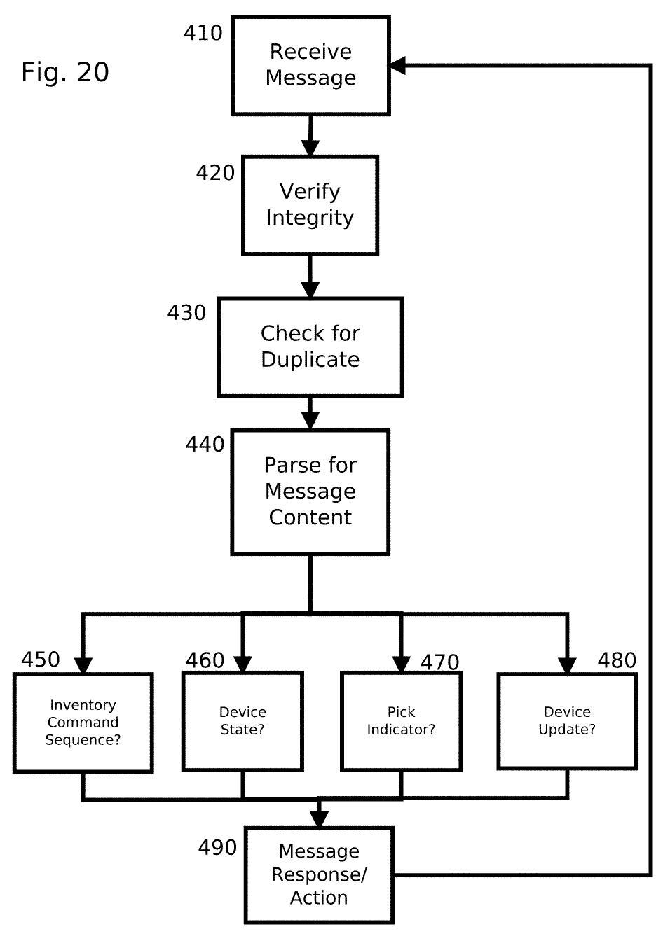

FIG. 20 illustrates a process of message 90 processing. At step 410, a packet having a message 90 is received 410. The integrity of the packet or message 90 may be verified using CRC or other means in the art. At step 430, the packet is checked to verify that is not a duplicate packet. As illustrated in FIG. 2, a shelf tag 20 can be within the transmission region 98 of multiple shelf tag hubs 80, leading to the possibility of a duplicate message 90 receipt. As mentioned, the message 90 can contain a nonce. The receiving device 20 80 can use the nonce to compare to prior received packet nonces to verify that the packet is not a duplicate transmission. If so, the packet is discarded and further processing terminated. If not, the nonce is stored for comparison against future packets.

At step 440, the message 90 is parsed for its content and a response or action taken 490. For example, where the message 90 content is an inventory command sequence 450, the inventory command is executed in response 490. For example, where the message 90 content is a device state inquiry 460, the sought device state is returned in response 490. For example, where the message 90 content is a pick indicator instruction 470, a pick indicator 27 is activated in response 490. For example, where the message 90 content is a device update 480, a device update sequence is executed in response 490. Further processes may occur in response to the message 90 content. For example, where a device state inquiry is for voltage and a low voltage value is returned in response, a second state confirmation message 90 may be transmitted or an alert may be generated for servicing the device.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A shelf tag hub for inventory related communication with one or more shelf tags, said shelf tag hub comprising:
said shelf tag hub comprising a processor, memory, a wireless network adapter;
said wireless network adapter being a modified protocol radio; and
said wireless network adapter configured with a transmission signal for a target transmission distance, defining a transmission region for communication with shelf tags disposed therein.

2. The shelf tag hub of claim 1, further comprising a second network adapter, said second network adapter communicating over a separate network.

3. The shelf tag hub of claim 1, wherein said shelf tab hub is configured as an advertising receiver.

4. The shelf tag hub of claim 1, further providing a shelf tag, said a shelf tag comprising a processor, memory, a wireless network adapter configured with a modified protocol.

5. The shelf tag hub of claim 4, wherein said shelf tab is configured as an advertising broadcaster.

6. The shelf tag hub of claim 1, wherein said shelf tag hub is configured to change its wireless network adapter transmission parameters in order to maximize message throughput to said shelf tags.

7. The shelf tag hub of claim 6, wherein said wireless network adapter transmission parameters are adjusted in response to message volume.

8. The shelf tag hub of claim 6, wherein said wireless network adapter transmission parameters are adjusted in response to message priority.

9. The shelf tag hub of claim 6, wherein said wireless network adapter transmission parameters are adjusted in response to packet collisions.

10. The shelf tag hub of claim 6, wherein said changed transmission parameter is transmission distance.

11. The shelf tag hub of claim 6, wherein said changed transmission parameter is the frequency of packet transmissions.

12. The shelf tag hub of claim 6, wherein said changed transmission parameter is package delay based on message priority.

13. The shelf tag hub of claim 6, wherein said changed transmission parameter is an advertising channel sequence change.

14. The shelf tag hub of claim 1, wherein said shelf tag hub is configured to determine and transmit target wireless network adapter transmission parameters to one or more shelf tags in order to maximize message throughput.

15. The shelf tag hub of claim 14, wherein said wireless network adapter transmission parameters are adjusted in response to message volume.

16. The shelf tag hub of claim 14, wherein said wireless network adapter transmission parameters are adjusted in response to message priority.

17. The shelf tag hub of claim 14, wherein said wireless network adapter transmission parameters are adjusted in response to packet collisions.

18. The shelf tag hub of claim 14, wherein said changed transmission parameter is transmission distance.

19. The shelf tag hub of claim 14, wherein said changed transmission parameter is the frequency of packet transmissions.

20. The shelf tag hub of claim 14, wherein said changed transmission parameter is package delay based on message priority.

21. The shelf tag hub of claim 14, wherein said changed transmission parameter is an advertising channel sequence change.

22. The shelf tag of claim 4, further configured to process a received message by the following steps:
said shelf tag parsing the packet for its message; and
responding to the message according to its content.

23. The shelf tag of claim 22, further configured to verify the packet by a cyclic redundancy check.

23. The shelf tag of claim 22, further configured to verify original packet by comparison of a nonce in the current message to prior nonces.

24. The shelf tag of claim 22, further configured to verify original packet by comparison of a nonce in the current message to prior nonces.

25. The shelf tag of claim 22, further configured to execute an inventory command in response to inventory command sequence message.

26. The shelf tag of claim 22, further configured to provide device state in response to a device state inquiry message content.

27. The shelf tag of claim 22, further configured to execute a device update sequence in response to a device update message.

28. The shelf tag of claim 22, further configured to activate a pick indicator in response to a pick indicator instruction message.
